(19) United States
(12) Patent Application Publication
(10) Pub. No.: US 2026/0270650 A1
(43) Pub. Date: Sep. 10, 2026

(54) ROBOT CALLING SYSTEM BASED ON LORA, AND METHOD, DEVICE AND STORAGE MEDIUM

(71) Applicant: SHENZHEN PUDU TECHNOLOGY CO., LTD., Shenzhen (CN)

(72) Inventors: Longfei DENG, Shenzhen (CN); Xiaofeng GONG, Shenzhen (CN)

(21) Appl. No.: 18/876,498

(22) PCT Filed: Aug. 4, 2023
(86) PCT No.: PCT/CN2023/111169

§ 371 Date: Dec. 18, 2024

(30) Foreign Application Priority Data
Dec. 15, 2022 (CN) 202211616673.0

(51) Int. Cl. H04W 4/029; G05D 1/226; G05D 1/246; G05D 1/656; G05D 105/30; G06Q 50/12; H04W 84/02

(52) U.S. Cl. CPC H04W 4/029; G05D 1/226; G05D 1/246; G05D 1/656; G05D 2105/30; G06Q 50/12; H04W 84/022

(57) ABSTRACT

In one aspect, a robot calling system based on LoRa includes: a LoRa gateway, at least one call terminal and a robot cluster that establish a LoRa communication with the LoRa gateway. The call terminal is configured to perform encapsulation on the basis of a custom serial communication protocol to generate a robot call request, and send the robot call request to the LoRa gateway; the LoRa gateway is configured to determine a target robot from the robot cluster in response to the robot call request, and send a control instruction to the target robot; and the target robot is configured to go, in response to the control instruction, to the position where the call terminal is located.

### CROSS-REFERENCE TO RELATED APPLICATIONS

The present application is a U.S. national stage application of PCT international application PCT/CN2023/111169 filed on Aug. 4, 2023, which claims priority to Chinese patent application No. 202211616673.0, titled “ROBOT CALLING SYSTEM BASED ON LORA, AND METHOD, DEVICE AND STORAGE MEDIUM”, filed with the China National Intellectual Property Administration on Dec. 15, 2022, the entire content of which is incorporated herein by reference.

### TECHNICAL FIELD

The present disclosure relates to the field of robot technologies, and in particular, to a robot calling system based on LoRa, a method, a device and a storage medium.

### BACKGROUND

With the development of robot technologies, more and more industries are beginning to use robots, especially in the catering industry. In order to reduce labor costs and enhance efficiency, robots are gradually being adopted to replace some labor.

### SUMMARY

According to various embodiments of the present disclosure, a robot calling system based on LoRa, a method, a computer device, a computer-readable storage medium and a computer program product are provided.

In a first aspect, the present disclosure provides a robot calling system based on LoRa. The calling system includes: a LoRa gateway, at least one calling terminal and a robot cluster, the at least one terminal and the robot cluster establishing LoRa communication with the LoRa gateway.

The calling terminal is configured to encapsulate and generate a robot call request based on a custom serial communication protocol, and send the robot call request to the LoRa gateway.

The LoRa gateway is configured to determine a target robot from the robot cluster in response to the robot call request, and send a control instruction to the target robot.

The target robot is configured to go to a location of the calling terminal in response to the control instruction.

In a second aspect, the present disclosure further provides a calling method, applied to a LoRa gateway. The method includes:

obtaining a robot call request encapsulated and generated by a calling terminal based on a custom serial communication protocol;

determining a target robot from a robot cluster in response to the robot call request; and

sending a control instruction to the target robot, such that the target robot goes to a location of the calling terminal in response to the control instruction.

In a third aspect, the present disclosure further provides another calling method, applied to a calling terminal. The method includes:

encapsulating and generating a robot call request based on a custom serial communication protocol, and sending the robot call request to a LoRa gateway, such that the LoRa gateway determines a target robot based on the robot call request, and sends a control instruction to the target robot, such that the target robot goes to a location of the calling terminal in response to the control instruction.

In a fourth aspect, the present disclosure further provides another a calling method, applied to a robot. The method includes:

obtaining a control instruction sent by a LoRa gateway, the control instruction being generated by the LoRa gateway based on a robot call request sent by a calling terminal; and

going to a location of the calling terminal in response to the control instruction.

In a fifth aspect, the present disclosure further provides a computer device. The computer device includes a memory and a processor. The memory stores a computer program, and the processor implements the steps of the above method when executing the computer program.

In a sixth aspect, the present disclosure further provides a computer-readable storage medium. The computer-readable storage medium stores a computer program, and when the computer program is executed by a processor, the steps of the above method are implemented.

In a seventh aspect, the present disclosure further provides a computer program product. The computer program product includes a computer program, and when the computer program is executed by a processor, the steps of the above method are implemented.

One or more embodiments of the present disclosure will be described in detail below with reference to drawings. Other features, objects and advantages of the present disclosure will become more apparent from the description, drawings, and claims.

### BRIEF DESCRIPTION OF THE DRAWINGS

In order to describe the technical solutions of the embodiments of the present disclosure or the conventional technologies more clearly, the accompanying drawings required for describing the embodiments or for describing the conventional technologies will be briefly introduced as follows. Apparently, the accompanying drawings, in the following description, illustrate merely some embodiments of the present disclosure, for a person of ordinary skill in the art, drawings of other embodiments can also be obtained according to these accompanying drawings without making any creative efforts.

FIG. 1 is a diagram illustrating an architecture of a robot calling system based on LoRa in an embodiment.

FIG. 2 is a flow diagram illustrating a calling method in an embodiment.

FIG. 3 is a flow diagram illustrating a calling method in another embodiment.

FIG. 4 is a schematic diagram illustrating a custom SLIP format in an embodiment.

FIG. 5 is a flow diagram illustrating a calling method in another embodiment.

FIG. 6 is a flow diagram illustrating a calling method in another embodiment.

FIG. 7 is a block diagram illustrating a configuration of a calling device in an embodiment.

FIG. 8 is a block diagram illustrating a configuration of a calling device in another embodiment.

FIG. 9 is a block diagram illustrating a configuration of a calling device in another embodiment.

FIG. 10 is a diagram illustrating an internal configuration of a computer device in an embodiment.

### DETAILED DESCRIPTION OF THE EMBODIMENTS

In order to facilitate understanding of the present disclosure, the present disclosure will be described more fully below with reference to the relevant accompanying drawings. Preferred embodiments of the present disclosure are presented in the accompanying drawings. However, the present disclosure may be implemented in many different forms and is not limited to the embodiments described herein. Rather, these embodiments are provided for the purpose of making the present disclosure more thorough and comprehensive.

Unless otherwise defined, all technical and scientific terms used herein have the same meaning as commonly understood by a person of ordinary skill in the art to which the present disclosure belongs. The terms used herein in the specification of the application are for the purpose of describing specific embodiments only, and are not intended to limit the application. The term “and/or” as used herein includes any and all combinations of one or more of the relevant listed items.

In a current food service robot service system, customers use calling terminals to request food service robots to their locations to provide services. Since the calling terminals generally use WIFI networks to communicate with the food service robots, data transmission is highly dependent on the WIFI network. Once the WIFI network fluctuates or is disconnected, data reception is delayed or data is lost, resulting in poor stability and accuracy of the data transmission, which leads to a low call success rate.

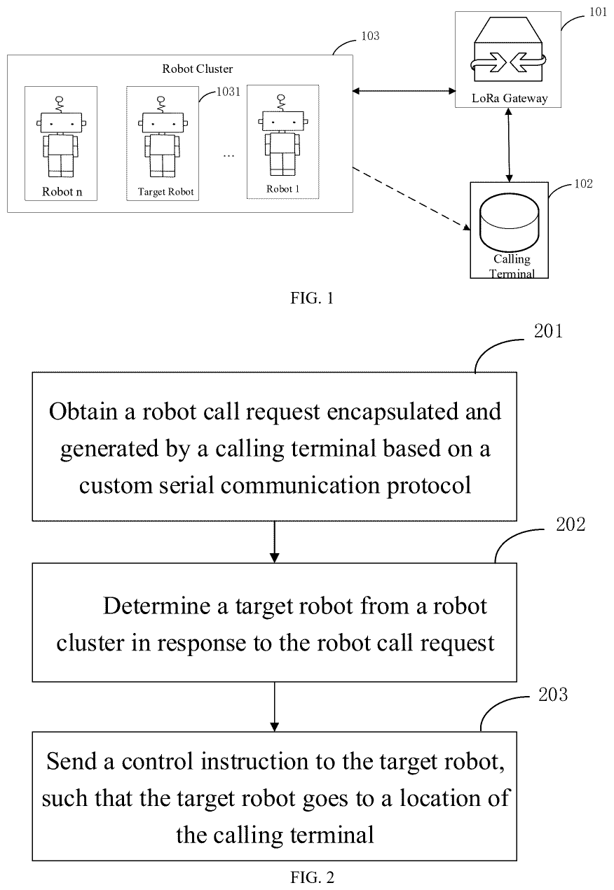

In some embodiments, as shown in FIG. 1, a diagram illustrating an architecture of a robot calling system based on LoRa is provided. Referring to FIG. 1, the system includes a LoRa gateway 101, at least one calling terminal 102 and a robot cluster 103 that establish LoRa communication with the LoRa gateway. The LoRa gateway 101 performs LoRa communication with robots in the robot cluster 103 and the calling terminal 102, respectively. After receiving a robot call request, the LoRa gateway 101 determines a target robot 1031 from the robot cluster 103, and controls the target robot 1031 to go to a location of the calling terminal 102. It should be noted that the robot cluster 103 includes at least one robot.

The target robot 103 is a robot in the robot cluster 103 connected to the LoRa gateway 101, and is configured to go to the calling terminal 102 to provide services. It can be understood that since the calling terminal 102, the robots in the robot cluster 103 and the LoRa gateway 101 form a LoRa local area network (LAN), even if the network is disconnected or the network fluctuates, data transmission between the calling terminal 102, the robots in the robot cluster 103 and the LoRa gateway 101 will not be affected. In other words, the robots in the robot cluster 103 can respond to the robot call request in time, so as to quickly reach the location of the calling terminal 102, thereby improving the call success rate.

Optionally, compared with 4G, WIFI, etc., the LoRa LAN can achieve a longer transmission distance with the same power consumption, and the data transmission will not be affected by the surge in the number of mobile terminals or WIFI terminals in the environment.

Exemplarily, the calling terminal 102 encapsulates and generates a robot call request based on a custom serial communication protocol, and sends the robot call request to the LoRa gateway 101. In response to the robot call request, the LoRa gateway 101 determines a target robot 1031 from the robot cluster 103 and sends a control instruction to the target robot 1031. The target robot 1031 goes to a location of the calling terminal 102 in response to the control instruction.

The custom serial communication protocol is a self-defined serial communication protocol. It can be understood that the custom serial communication protocol may be a completely new custom serial communication protocol, or may be obtained by custom modifying an existing serial communication protocol. Data frames communicated between the robots, the LoRa gateway and the calling terminal can all be encapsulated using the custom serial communication protocol.

In the robot calling system based on LoRa described above, by establishing the robot calling system based on LoRa, and encapsulating and generating the robot call request based on the custom serial communication protocol, the target robot is determined in response to the robot call request, and the control instruction is generated to control the target robot to the location of the calling terminal, thereby improving the accuracy and stability of data transmission, and thus improving the call success rate.

In some embodiments, the control instruction includes a unique identification of the calling terminal. The target robot 1031 is further configured to: determine a map location of the calling terminal 102 based on the unique identification of the calling terminal 102, and go to the location of the calling terminal 102 based on the map location.

The map location is a location of the calling terminal in an operating environment of the robot calling system based on LoRa. For example, if the operating environment is a restaurant, a location of the calling terminal in a map of the restaurant is the map location.

Exemplarily, the target robot 1031 determines the map location of the calling terminal 102 based on a corresponding relationship between the unique identification of the calling terminal 102 and the map location, and goes to the location of the calling terminal 102 based on the map location.

In an optional embodiment, the target robot 1031 pre-stores a map of the operating environment. The map includes the map location (specifically including X, Y coordinates, and may further including angle information θ) of the calling terminal 102 in the operating environment, and binding information of the unique identification of the corresponding calling terminal 102.

When the target robot 1031 receives the unique identification of the calling terminal 102, the map location of the corresponding calling terminal 102 can be determined based on the unique identification.

In the above embodiment, the location of the calling terminal can be accurately determined based on the corresponding relationship between the unique identification of the calling terminal and the map location.

In some embodiments, the control instruction includes a map location of the calling terminal 102, and the target robot 1031 is further configured to: go to the location of the calling terminal 102 based on the map location. The map location is determined by the LoRa gateway 101 based on the unique identification of the calling terminal 102 in the robot call request.

Exemplarily, upon receiving the robot call request sent by the calling terminal 102, the LoRa gateway 101 determines the map location of the calling terminal 102 based on the corresponding relationship between the unique identification of the calling terminal 102 in the robot call request and the map location, and generates the control instruction including the map location. Upon receiving the control instruction including the map location, the target robot 1031 goes to the location of the calling terminal 102 based on the map location.

In an optional embodiment, the LoRa gateway 101 may only include a gateway. The gateway is configured to achieve communication between the calling terminal 102 and the robot cluster 103.

In an optional embodiment, the LoRa gateway 101 includes a gateway and a cloud platform.

In an optional embodiment, the gateway and the cloud platform can communicate with each other. The gateway is responsible for communicating with the calling terminal 102, and the cloud platform is responsible for communicating with the robot cluster 103.

Optionally, the communication method between the gateway and the cloud platform is not limited in the present disclosure.

In another optional embodiment, the gateway may be configured to achieve communication between the calling terminal 102 and the robot cluster 103, and the cloud platform may be configured to assist the gateway in the calculation of relevant data.

For example, in an optional embodiment, the LoRa gateway 101 pre-stores a map of the corresponding operating environment. The map includes the map location (specifically including X, Y coordinates, and may further including angle information θ) of the calling terminal 102 in the operating environment, and binding information of the unique identification of the corresponding calling terminal 102. Upon receiving the robot call request sent by the calling terminal 102, the LoRa gateway 101 determines the map location of the calling terminal 102 based on the corresponding relationship between the unique identification of the calling terminal 102 in the robot call request and the map location, and sends the map location as a part of the control instruction to the target robot 1031, so that upon receiving the control instruction including the map location, the target robot 1031 goes to the location of the calling terminal 102 based on the map location.

In an optional embodiment, the gateway may pre-store a map of the corresponding operating environment and perform calculations.

In other embodiments, the cloud platform may pre-store a map of the corresponding operating environment. Upon obtaining the unique identification of the calling terminal 102 from the gateway, the cloud platform calculates the map location of the calling terminal 102 corresponding to the unique identification, and sends the map location to the gateway. Further, the gateway sends the map location as a part of the control instruction to the target robot 1031, so that upon receiving the control instruction including the map location, the target robot 1031 goes to the location of the calling terminal 102 based on the map location.

In some embodiments, the custom serial communication protocol has a custom session mode field. The target robot 1031 is further configured to encapsulate and generate an arrival message based on the custom serial communication protocol after arriving at the location of the calling terminal 102, and send the arrival message to the LoRa gateway 101. The arrival message is encapsulated with a second session mode identification, and a second session mode represented by the second session mode identification refers to sending response information that does not carry relevant data.

The LoRa gateway 102 is further configured to send an arrival prompt instruction to the calling terminal 102 in response to the arrival message, and return the response information that does not carry relevant data to the target robot 1031 based on the second session mode identification.

The calling terminal 102 is further configured to output arrival prompt information in response to the arrival prompt instruction. The arrival prompt information indicates that the target robot 1031 has arrived at the calling terminal.

The session mode refers to a communication mode between an initiating session party and a requested session party. The session mode may be set according to the application scenario, and can be set to one or more.

It can be understood that a session mode field is defined in the custom serial communication protocol, and a data frame encapsulated based on the custom serial communication protocol carries the session mode field. The data frame sent by the initiating session party carries the session mode field, and the requested session party determines a session mode of the current session by identifying the session mode field in the data frame, so as to return the corresponding data frame. Information written into the session mode field for representing the session mode is the session mode identification. It can be understood that different session modes correspond to different session mode fields. Based on different session mode fields, there may be a first session mode, a second session mode, a third session mode, a fourth session mode, and so on. A first session mode identification refers to information representing the first session mode written into the session mode field, and a second session mode identification refers to information representing the second session mode written into the session mode field.

It can be understood that the requested session party may determine that a data frame that does not carry relevant data needs to be returned to the initiating session party by identifying the field corresponding to the second session mode in the received data frame. For example, the custom second session mode field in the custom serial communication protocol is represented as 0x02. After arriving at the location of the calling terminal, the target robot sends an arrival prompt information to the LoRa gateway. In a case that the session mode field of the data frame received by the LoRa gateway is 0x02, it means that the LoRa gateway needs to return a data frame that does not carry data to the target robot, indicating that the LoRa gateway has known that the target robot has arrived at the location of the calling terminal.

The arrival message refers to a message sent to the LoRa gateway when the target robot arrives at the calling terminal, indicating that the target robot has arrived at the calling terminal. The arrival message includes at least one of an address of the calling terminal, an arrival instruction, or current location information.

The arrival prompt instruction is an instruction sent by the LoRa gateway to prompt the calling terminal that the target robot has arrived at the calling terminal.

The arrival prompt information is a prompt information generated by the calling terminal when the target robot arrives at the location of the calling terminal, and is configured to prompt that the target robot has arrived. The arrival prompt information includes at least one of a sound prompt or a light prompt. For example, the arrival prompt information may be a voice broadcast that the robot has arrived, or a light that prompts the robot has arrived, which is not limited in this embodiment.

In some embodiments, as shown in FIG. 2, a flow diagram illustrating a calling method is provided. Taking the method applied to the LoRa gateway 101 in FIG. 1 as an example, the method includes the following steps.

In step 201, a robot call request encapsulated and generated by a calling terminal based on a custom serial communication protocol is obtained.

Exemplarily, in a case that a user needs to call a robot, a robot calling operation may be performed by using the calling terminal. In response to the robot calling operation, the calling terminal may encapsulate and generate the robot call request based on the custom serial communication protocol, and send the robot call request to the LoRa gateway.

In some embodiments, when the calling terminal encapsulates and generates the robot call request based on the custom serial communication protocol, a first session mode identification may be written into the session mode field of the custom serial communication protocol. Therefore, the robot call request will carry the first session mode identification, indicating that a first session mode is used for communication. The LoRa gateway can extract the first session mode identification from the obtained robot call request.

In step 202, in response to the robot call request, a target robot is determined from the robot cluster.

Exemplarily, the LoRa gateway determines the target robot from the robot cluster based on at least one of location information or state information in response to the robot call request.

The location information is real-time location information of the robot. The state information is configured to indicate whether the target robot is in an idle state. Optionally, the state information specifically includes an idle state and an occupation state. The occupation state may be an overall state, which may include sub-states such as delivering food, returning dishes, and being called, which are not limited here.

In an optional embodiment, the robot may report its location information and state information at a preset frequency.

In an optional embodiment, the LoRa gateway may send an inquiry to at least one robot at a preset frequency, and obtain the location information and the state information reported by the robot. Alternatively, when the LoRa gateway needs to obtain the location information and the state information of the robot, the LoRa gateway sends a temporary inquiry to at least one robot, and obtains the location information and the state information reported by the robot.

In an optional embodiment, the LoRa gateway may only include a gateway. The gateway is configured to achieve communication between the calling terminal and the robot cluster.

In an optional embodiment, the LoRa gateway includes a gateway and a cloud platform.

In an optional embodiment, the gateway and the cloud platform can communicate with each other. The gateway is responsible for communicating with the calling terminal 102, and the cloud platform is responsible for communicating with the robot cluster.

Optionally, the communication method between the gateway and the cloud platform is not limit in the present disclosure.

In another optional embodiment, the gateway may be configured to achieve communication between the calling terminal and the robot cluster 103, and the cloud platform is configured to assist the gateway in the calculation of relevant data.

In an optional embodiment, the LoRa gateway determines the target robot from the robot cluster based on at least one of location information or state information in response to the robot call request. Specifically, the gateway may determine the target robot from the robot cluster based on at least one of the location information or the state information. Alternatively, the cloud platform may determine the target robot from the robot cluster based on at least one of the location information or the state information, which is not limited here.

In step 203, a control instruction is sent to the target robot, such that the target robot goes to a location of the calling terminal in response to the control instruction.

Exemplarily, when the target robot is determined, the LoRa gateway sends the control instruction to the target robot. The target robot switches the state information to the occupation state in response to the control instruction, and goes to the location of the calling terminal based on the control instruction.

In some embodiments, after sending the control instruction to the target robot such that the target robot goes to the location of the calling terminal in response to the control instruction, the LoRa gateway determines that the current session mode is the first session mode based on the session mode field in the received robot call request, and returns a data frame matching the first session mode to the calling terminal. The data frame carries call success response information.

The call success response information is response information configured to indicate that the call is successful. It can be understood that when the call to the robot is successful, the LoRa gateway may return a corresponding data frame to the calling terminal, which carries the call success response information, such that the calling terminal knows that the call to the robot is successful.

It should be noted that the content of the returned call success response information will be different for different session modes. In this embodiment, the robot call request carries the first session mode identification, indicating that the session mode for responding to the robot call request is the first session mode. After the LoRa gateway successfully calls the robot, the matched call success response information may be generated according to the first session mode.

In the calling method described above, by establishing the robot calling system based on LoRa, and encapsulating and generating the robot call request based on the custom serial communication protocol, the target robot is determined in response to the robot call request, and the control instruction is generated to control the target robot to go to the location of the calling terminal, thereby improving the accuracy and stability of data transmission, and thus improving the call success rate.

In some embodiments, the first session mode represented by the first session mode identification refers to that response information carrying relevant data needs to be sent. The method further includes: if there is no target robot in an idle state, returning call failure response information to the calling terminal based on the first session mode identification.

It can be understood that the requested session party may determine that a data frame carrying relevant data needs to be returned to the initiating session party by identifying the field corresponding to the first session mode in the received data frame. For example, the custom first session mode field in the custom serial communication protocol is represented as 0x01. In a session in which the robot inquiries about a connection state from the LoRa gateway (there are four modes of connection state: unregistered, represented as 0x00; registered, represented as 0x01; logged in, represented as 0x02; and disconnected, represented as 0x03), if the session mode field in the data frame received by the LoRa gateway is 0x01, the data frame carrying relevant data returned by the LoRa gateway to the robot refers to a data frame carrying information about the connection state.

The call failure response information is response information configured to indicate a call failure. It can be understood that when the call to the robot fails, i.e., there is no target robot, the LoRa gateway may return a corresponding data frame to the calling terminal, which carries the call failure response information, such that the calling terminal knows that the call to the robot has failed.

Exemplarily, upon receiving the robot call request, the LoRa gateway finds that all robots connected to the LoRa gateway are occupied, i.e., there is no robot in an idle state. In this case, based on the first session mode identification, it is determined that the current session mode is the first session mode, and the corresponding data frame is returned to the calling terminal. The data frame carries the call failure response information.

In this embodiment, the call failure response information is returned to the calling terminal through the first session mode identification, and the calling terminal is notified of the call situation in time, thereby avoiding the calling terminal from making a long call and causing a waste of resources.

In some embodiments, the custom serial communication protocol has a custom session mode field, and the robot call request includes a first session mode identification in the session mode field. The custom serial communication protocol further has a custom source address field, and the robot call request further includes an address of the calling terminal in the source address field. After sending the control instruction to the target robot, such that the target robot goes to the location of the calling terminal in response to the control instruction, the method further includes: returning call success response information matching the first session mode identification to the calling terminal based on the address of the calling terminal.

The source address field refers to a source address field in the data frame encapsulated in the custom serial communication protocol, i.e., an address field of the initiating session party. In order to distinguish which of the LoRa gateway, the robot or the calling terminal is the initiating session party, their addresses should be different. It can be understood that the requested session party may know the address of the initiating session party by identifying the source address field in the data frame, so as to accurately return the corresponding data frame. For example, the address field of the LoRa gateway is represented as 0x00, the address field of the calling terminal is represented as 0x01, and the address field of the robot is represented as 0x02. In a session, in a case that the source address field in the data frame received by the LoRa gateway is 0x02, it indicates that the initiating session party is a robot, and then the LoRa gateway returns the corresponding data frame to the robot based on the source address field.

In this embodiment, by determining the source address field, accurate data transmission is realized and the call success rate is improved.

In some embodiments, determining the target robot from the robot cluster in response to the robot call request includes: obtaining state information reported by the robot cluster; and determining a robot whose state information is an idle state as the target robot from the robot cluster based on the state information.

The state information includes but is not limited to any one of an idle state, an occupation state and a forced occupation state.

It can be understood that the idle state indicates that the robot is not occupied, the occupation state indicates that the robot is occupied, and the forced occupation state indicates that the robot encounters an emergency situation while going to the location of the calling terminal, for example, the robot suddenly shuts down, encounters an obstacle and is unable to move, etc.

Exemplarily, upon receiving the robot call request, the LoRa gateway obtains the state information reported by the connected robot cluster, and the state information includes any one of the idle state, the occupation state, and the forced occupation state. Further, based on the state information, the LoRa gateway determines the robot of which the state information is an idle state as the target robot from the robot cluster.

In some embodiments, determining, based on state information, the robot of which the state information is an idle state as the target robot from the robot cluster includes: if there is only one robot in an idle state, determining the robot as the target robot; and if multiple robots in an idle state are found, determining the target robot base on location information.

In the above embodiment, the target robot in an idle state is determined based on the state information, so that the target robot can go to the location of the calling terminal in time, thereby improving the call success rate.

In some embodiments, determining the target robot from the robot cluster in response to the robot call request includes: obtaining state information and location information reported by the robot cluster; obtaining a map location of the calling terminal; determining robots whose state information is an idle state from the robot cluster based on the state information; and determining a robot closest to the calling terminal as the target robot from the robots whose state information is an idle state based on the map location of the calling terminal and the location information.

Exemplarily, the LoRa gateway obtains the state information and the location information reported by the robot cluster, as well as the map location of the calling terminal. In a case that at least two robots whose state information is an idle state are determined from the robot cluster based on the state information, the robot closest to the calling terminal is determined as the target robot from the robots whose state information is an idle state based on the map location of the calling terminal and the location information.

It should be noted that being closest to the calling terminal may mean that a straight-line distance between the robot and the calling terminal is the shortest, or an actual path between the robot and the calling terminal is the shortest, or a map planned path between the robot and the calling terminal is the shortest, which is not limited in this embodiment.

In the above embodiment, in the case that there are at least two robots in an idle state, the robot closest to the calling terminal is determined as the target robot, which can ensure that the target robot reaches the calling terminal quickly, thereby shortening the call time.

In some embodiments, after the target robot arrives at the location of the calling terminal, an arrival message encapsulated based on the custom serial communication protocol is received from the target robot. A second session mode identification is encapsulated in the arrival message, and a second session mode represented by the second session mode identification refers to sending response information that does not carry relevant data. In response to the arrival message, the calling terminal is controlled to output arrival prompt information, and then response information that does not carry relevant data is returned to the target robot based on the second session mode identification. The arrival prompt information indicates that the robot has arrived at the calling terminal.

Exemplarily, after the target robot arrives at the calling terminal, it generates and encapsulates an arrival message based on the custom serial communication protocol, and sends the arrival message to the LoRa gateway. Upon receiving the arrival message, the LoRa gateway sends an arrival prompt instruction to the calling terminal to prompt the calling terminal that the robot has arrived. Further, the calling terminal outputs the arrival prompt information in response to the arrival prompt instruction.

In this embodiment, based on the second session identification, it is determined that the session mode between the recipient of the robot call request and the robot is the second session mode, so that data can be transmitted accurately, thereby ensuring the reliability of data transmission. Meanwhile, after the target robot arrives at the location of the calling terminal, the calling terminal outputs arrival the prompt information to prompt that the target robot has arrived, so as to prompt a user that the target robot has arrived.

In some embodiments, in a case that a one-way message encapsulated based on the custom serial communication protocol and carrying a third session mode identification is received, no response is made to the received one-way message. A third session mode represented by the third session mode identification refers to no response required.

The one-way message refers to a message sent in one-way, i.e., a sender is only responsible for sending the message and does not wait for a response.

It can be understood that the one-way message is determined according to a session scenario. For example, in a session scenario where the robot sends heartbeat data to the LoRa gateway, or the robot reports location information and state information to the LoRa gateway, the message sent by the robot is a one-way message, and the receiver does not need to respond.

The third session mode identification refers to information representing the third session mode written into the session mode field.

It can be understood that the requested session party may determine that a data frame that does not carry relevant data needs to be returned to the initiating session party by identifying the field corresponding to the third session mode in the received data frame. For example, the custom third session mode field in the custom serial communication protocol is represented as 0x03. In a session in which the robot sends heartbeat data to the LoRa gateway at regular intervals, and the heartbeat data is used to indicate that the robot is online, if the session mode field of the data frame received by the LoRa gateway is 0x03, it is indicated that the LoRa gateway does not need to respond to the received data frame.

In this embodiment, based on the third session identification, it is determined that the session mode between the LoRa gateway and the robot is the third session mode, so that data can be transmitted accurately, thereby ensuring the reliability of data transmission.

In some embodiments, during the movement of the target robot to the location of the calling terminal, state information of the target robot is determined. If the state information indicates that the target robot is forcibly occupied, a response processing for the forced occupation is performed.

The response processing for the forced occupation refers to a processing performed in a case that the state information of the target robot is in the forced occupation state.

Exemplarily, if the target robot runs out of power and shuts down while going to the location of the calling terminal, the target robot will switch the state information to the forced occupation state before shutting down. After determining that the state information of the target robot is in the forced occupation state, the LoRa gateway will perform the response processing for the forced occupation. For example, the LoRa gateway may send a call failure message to the calling terminal, and the calling terminal may display the call failure. Alternatively, the LoRa gateway may obtain the state information of all connected robots again, find the robot that is closest to the calling terminal and is in an idle state as the target robot, and control the target robot to go to the location of the calling terminal.

In this embodiment, by determining the state information of the target robot in the process of going to the calling terminal, the calling terminal can be promptly notified of the call failure or a new robot can be rearranged to go to the calling terminal in the case that the state information of the target robot is the forced occupation state, thereby improving the call success rate.

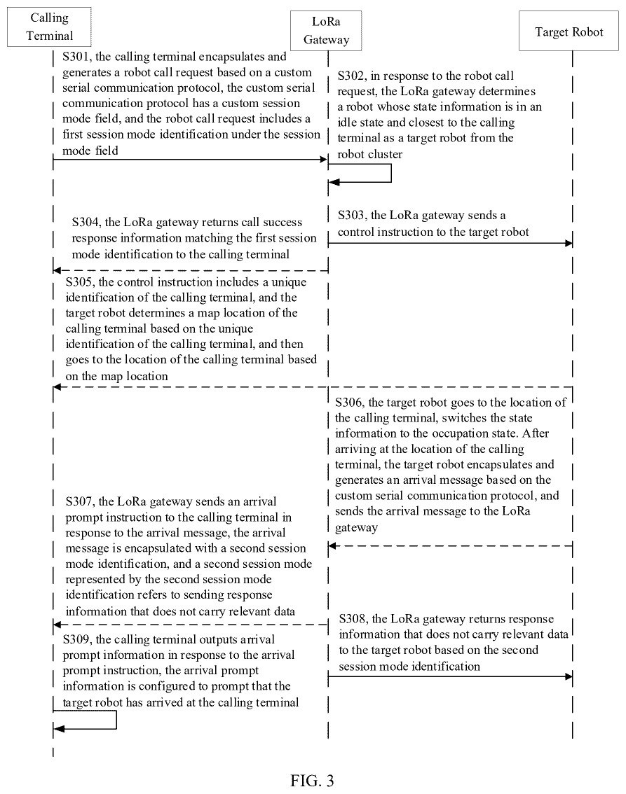

In another embodiment, as shown in FIG. 3, another calling method is provided. The method specifically includes the following steps.

In step S301, the calling terminal encapsulates and generates a robot call request based on a custom serial communication protocol. The custom serial communication protocol has a custom session mode field, and the robot call request includes a first session mode identification in the session mode field.

In step S302, in response to the robot call request, the LoRa gateway determines a robot whose state information is an idle state and closest to the calling terminal as a target robot from the robot cluster.

In step S303, the LoRa gateway sends a control instruction to the target robot.

In step S304, the LoRa gateway returns call success response information matching the first session mode identification to the calling terminal.

In some embodiments, if there is no target robot in an idle state, call failure response information is returned to the calling terminal based on the first session mode identification.

In step S305, the control instruction includes a unique identification of the calling terminal, and the target robot determines a map location of the calling terminal based on the unique identification of the calling terminal and then goes to the location of the calling terminal based on the map location.

Furthermore, during the movement of the target robot to the location of the calling terminal, the LoRa gateway determines state information of the target robot. If the state information indicates that the target robot is forcibly occupied, a call failure message may be sent to the calling terminal. Alternatively, the LoRa gateway may obtain the state information of all connected robots again, find the robot that is closest to the calling terminal and is in an idle state as the target robot, and control the target robot to go to the location of the calling terminal.

In some embodiments, the control instruction includes a map location of the calling terminal. The target robot goes to the location of the calling terminal based on the map location. The map location is determined by the LoRa gateway through the unique identification of the calling terminal contained in the robot call request.

In step S306, the target robot goes to the location of the calling terminal, switches the state information to the occupation state. After arriving at the location of the calling terminal, the target robot encapsulates and generates an arrival message based on the custom serial communication protocol, and sends the arrival message to the LoRa gateway.

In step S307, the LoRa gateway sends an arrival prompt instruction to the calling terminal in response to the arrival message. The arrival message is encapsulated with a second session mode identification, and a second session mode represented by the second session mode identification refers to sending response information that does not carry relevant data.

In step S308, the LoRa gateway returns response information that does not carry relevant data to the target robot based on the second session mode identification.

In step S309, the calling terminal outputs arrival prompt information in response to the arrival prompt instruction. The arrival prompt information is configured to prompt that the target robot has arrived at the calling terminal.

In this embodiment, based on the session mode field in the robot call request encapsulated based on the custom serial communication protocol, the call success response information matching the first session mode identification is returned to the caller based on the first session mode field, thereby improving the accuracy and stability of data transmission. During the movement of the robot to the location of the calling terminal, timely response and processing are performed in a case that the state information of the target robot is a forced occupation state, thereby improving the call success rate.

In some embodiments, the custom serial communication protocol may be a custom protocol based on a serial line internet protocol (SLIP). In other words, the custom serial communication protocol of the present disclosure may be obtained by customizing the SLIP, and may be referred to as a custom SLIP format.

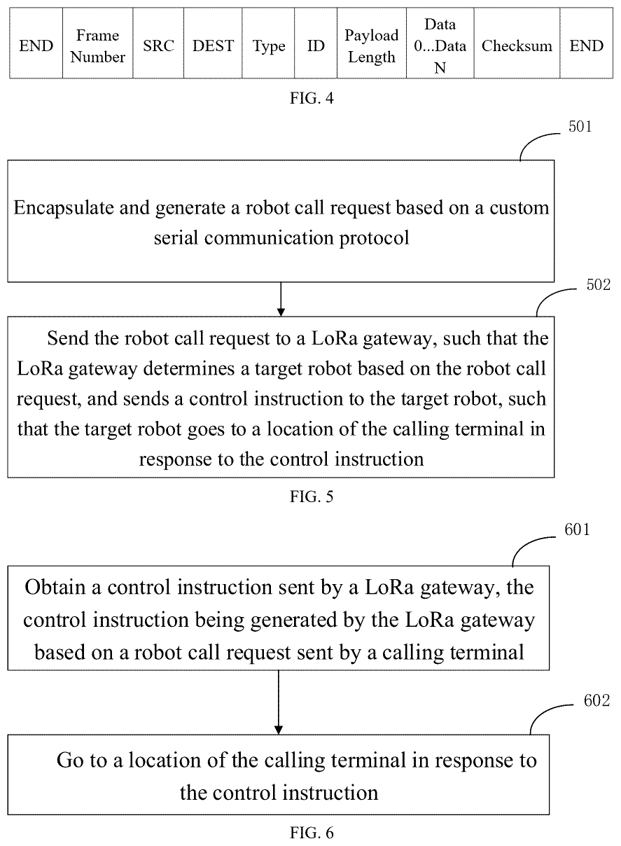

In some embodiments, referring to FIG. 4, a custom SLIP format is provided. The specific description and explanation of the custom SLIP format are as follows:

There are two END characters. Each data frame starts and stops with an END character.

There is a frame number. When two parties are communicating, the frame number automatically increases by 1 each time a frame is successfully transmitted. If three attempts to send a frame are unsuccessful, the frame number also automatically increase by 1 when a new frame is transmitted next time. When a value of the frame number accumulates to 255, the frame number starts to accumulate from 0 again, and the cycle continues. If the data frame is a response frame, the frame number is a number of the last received non-response frame, i.e., only the last non-response frame is responded to.

There are an address of the initiating session party, i.e., source address field (SRC) and an address of the requested session party (DEST). In each session, the data frame carries the addresses of the initiating session party and the requested session party. Exemplarily, an address of the LoRa gateway is defined as 0x00, an address of the calling terminal is defined as 0x01, and an address of the robot is defined as 0x10. When the SRC in a data frame is 0x00 and the DEST is 0x10, it can be determined that the data frame is sent by the LoRa gateway to the robot.

There is a Type field (session mode field). A session mode between the initiating session party and the requested session party is determined by determining the Type field. Exemplarily, it can be set that the initiating session party is Party A, and the requested session party is Party B. There is no master-slave relationship between the two parties except for the one-way session. In one-way session, the initiating session party is the master (Party A), and the requested session party is the slave (Party B).

In some embodiments, there may be three types of session modes between the Party A and the Party B. In a first session mode, the Party A initiates a session, and the Party B responds by carrying relevant data. In a second session mode, the Party A initiates a session, and the Party B responds by carrying no relevant data. In a third session mode, the Party A initiates a session, and the Party B does not need to respond. In this embodiment, optionally, the session modes may include, but are not limited to, the first session mode, the second session mode, and the third session mode. Exemplarily, the Type field of a sender may be set to 0x01, which is configured for the sender to read and query relevant information of a receiver, and the receiver needs to carry relevant data in response. The Type field of the sender may be set to 0x02, which is configured for the sender to set, modify, and notify the receiver, and the receiver needs to carry relevant data in response. The Type field of the sender may be set to 0x03, which is configured for the sender to set, modify, and notify the receiver, and the receiver does not need to carry relevant data in response. The Type field of the receiver may be set to 0x10, which is configured to indicate that the receiver carries relevant data in the response frame to the received data frame with the Type field of 0x01 or 0x02. The Type field of the receiver may be set to 0x20, which is configured to indicate that the receiver does not carry relevant data in the response frame to the received data frame with the Type field of 0x03. The Type field of the receiver may be set to 0x05, which is configured to indicate that the receiver does not respond to the received data frame with the Type field of 0x05, and mainly configured for real-time data transmission, transparent transmission, broadcast communication, etc.

There is an ID field (session scenario), i.e., the ID field is configured to determine a session scenario in which the initiating session party and the requested session party are in. Exemplarily, the ID field may be set according to the application scenario. For example, the ID 0x02 indicates that the initiating session party and the requested session party are querying the connection state. The ID 0x20 indicates that the initiating session party and the requested session party are transparently transmitting data. The ID 0x03 indicates that the initiating session party and the requested session party are transmitting heartbeat data.

There is a PayloadLength (size of data payload area), representing the amount of user data transmitted in the data frame. Exemplarily, the PayloadLength is configured to represent the amount of Data 0, . . . , Data N actually transmitted.

There are Data 0, . . . , Data N (0 to N pieces of data), representing the data actually transmitted.

There is a Checksum, configured to check whether the data transmission is incorrect. The verification principle as follows: (FrameNumber+SRC+DEST+Type+ID+PayloadLength+DATA 0+ . . . DATA n)\hat{ }0xFF. When replacement characters appear in the frame content, the checksum needs to be calculated using original data.

In this embodiment, the data frame in the session is encapsulated by using the custom SLIP format, ensuring the accuracy and stability of data transmission.

In some embodiments, as shown in FIG. 5, another calling method is provided. Taking the method applied to the calling terminal 102 as an example, the method includes the following steps:

In step 501, a robot call request is encapsulated and generated based on a custom serial communication protocol.

In step 502, the robot call request is sent to the LoRa gateway, such that the LoRa gateway determines a target robot based on the robot call request and sends a control instruction to the target robot, such that the target robot goes to a location of the calling terminal in response to the control instruction.

In some embodiments, the method further includes: outputting arrival prompt information in response to an arrival prompt instruction. The arrival prompt instruction is generated by the LoRa gateway in response to an arrival message sent by the target robot after the target robot arrives at the location of the calling terminal, and the arrival message is encapsulated and generated based on the custom serial communication protocol.

In some embodiments, as shown in FIG. 6, another calling method is provided. Taking the method applied to the target robot 1031 as an example, the method includes the following steps:

In step 601, a control instruction sent by the LoRa gateway is obtained. The control instruction is generated by the LoRa gateway based on a robot call request sent by the calling terminal.

In step 602, the target robot goes to a location of the calling terminal in response to the control instruction.

In some embodiments, the control instruction includes a unique identification of the calling terminal. The method further includes: determining a map location of the calling terminal based on the unique identification of the calling terminal; and going to the location of the calling terminal based on the map location.

In some embodiments, the control instruction includes a map location of the calling terminal. The method further includes: going to the location of the calling terminal based on the map location. The map location is determined by the LoRa gateway based on a unique identification of the calling terminal contained in the robot call request.

In some embodiments, the method further includes: encapsulating and generating an arrival message based on a custom serial communication protocol when arriving at the location of the calling terminal, and sending the arrival message to the LoRa gateway. The arrival message is encapsulated with a second session mode identification, and a second session mode represented by the second session mode identification refers to sending response information that does not carry relevant data.

It should be understood that although the individual steps in the flow diagrams involved of the embodiments as described above are shown sequentially as indicated by arrows, the steps are not necessarily performed sequentially in the order indicated by the arrows. Unless explicitly stated herein, the execution of these steps is not strictly limited in order and these steps can be performed in any other order. Moreover, at least some of the steps in the flow diagrams involved of the embodiments as described above may include a plurality of steps or a plurality of stages that are not necessarily performed at the same time, but may be performed at different times. The order in which these steps or stages are performed is not necessarily sequential, and these steps may be performed alternately or alternately with other steps or at least some of the steps or stages in other steps.

Based on the same inventive concept, embodiments of the present disclosure also provide a calling device for implementing the calling method as described above. The solution to the problem provided by the device is similar to the implementation of the method as described above, so the specific features in one or more embodiments of the calling device provided below may be referred to the features of the calling method above and will not be repeated here.

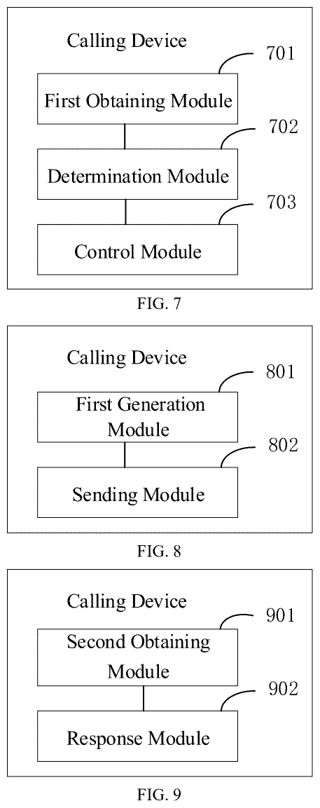

In some embodiments, as shown in FIG. 7, a calling device is provided. The calling device includes: a first obtaining module 701, a determination module 702, and a control module 703.

The first obtaining module 701 is configured to obtain a robot call request encapsulated and generated by a calling terminal based on a custom serial communication protocol.

The determination module 702 is configured to determine a target robot from a robot cluster in response to the robot call request.

The control module 703 is configured to send a control instruction to the target robot, such that the target robot goes to a location of the calling terminal in response to the control instruction.

In some embodiments, the determination module 702 is specifically configured to obtain state information reported by the robot cluster; and determine a robot whose state information is an idle state as the target robot from the robot cluster based on the state information.

In some embodiments, the determination module 702 is further specifically configured to obtain state information and location information reported by the robot cluster; obtain a map location of the calling terminal; determine robots whose state information is an idle state from the robot cluster based on the state information; and determine a robot closest to the calling terminal as the target robot from the robots whose state information is in an idle state based on the map location of the calling terminal and the location information.

In some embodiments, the custom serial communication protocol has a custom session mode field, and the robot call request includes a first session mode identification in the session mode field. The custom serial communication protocol further has a custom source address field, and the robot call request further includes an address of the calling terminal in the source address field. After sending the control instruction to the target robot, such that the target robot goes to the location of the calling terminal in response to the control instruction, the control module 703 is specifically configured to return call success response information matching the first session mode identification to the calling terminal based on the address of the calling terminal.

In some embodiments, a first session mode represented by the first session mode identification refers to that response information carrying relevant data needs to be sent. The control module 703 is further configured to: return call failure response information to the calling terminal based on the first session mode identification if there is no target robot in an idle state.

In some embodiments, the determination module 702 is further configured to determine state information of the target robot during the movement of the target robot to the location of the calling terminal; and perform a response processing for forced occupation in a case that the state information indicates that the target robot is forcibly occupied.

In some embodiments, the determination module 702 is further configured to: receive an arrival message sent by the target robot after the target robot arrives at the location of the calling terminal, the arrival message being encapsulated and generated based on the custom serial communication protocol, the arrival message being encapsulated a second session mode identification, a second session mode represented by the second session mode identification referring to sending response information that does not carry relevant data; and generate an arrival prompt instruction in response to the arrival message to control the calling terminal to output arrival prompt information based on the arrival prompt instruction and return response information that does not carry relevant data to the target robot based on the second session mode identification. The arrival prompt information is configured to prompt that the target robot has arrived at the calling terminal.

In some embodiments, as shown in FIG. 8, another calling device is provided. The calling device includes: a first generation module 801 and a sending module 802.

The first generation module 801 is configured to encapsulate and generate a robot call request based on a custom serial communication protocol.

The sending module 802 is configured to send the robot call request to a LoRa gateway, such that the LoRa gateway determines a target robot based on the robot call request and sends a control instruction to the target robot, such that the target robot goes to a location of the calling terminal in response to the control instruction.

In some embodiments, the calling device further includes a prompt module. The prompt module is configured to output arrival prompt information in response to an arrival prompt instruction. The arrival prompt instruction is generated by the LoRa gateway in response to an arrival message sent by the target robot when the target robot arrives at the location of the call terminal, and the arrival message is encapsulated and generated based on the custom serial communication protocol.

In some embodiments, as shown in FIG. 9, another calling device is provided. The calling device includes: a second obtaining module 901 and a response module 902.

The second obtaining module 901 is configured to obtain a control instruction sent by a LoRa gateway. The control instruction is generated by the LoRa gateway based on a robot call request sent by a calling terminal.

The response module 902 is configured to control a robot to go to a location of the calling terminal in response to the control instruction.

In some embodiments, the control instruction includes a map location of the calling terminal. The response module 902 is specifically configured to control the robot to go to the location of the calling terminal based on the map location. The map location is determined by the LoRa gateway through a unique identification of the calling terminal in the robot call request.

In some embodiments, the control instruction includes a unique identification of the calling terminal. The response module 902 is specifically configured to determine a map location of the calling terminal based on the unique identification of the calling terminal; and control the robot to go to the location of the calling terminal based on the map location.

In some embodiments, the calling device further includes a second generation module. The second generation module is configured to encapsulate and generate an arrival message based on a custom serial communication protocol when arriving at the location of the calling terminal, and send the arrival message to the LoRa gateway. The arrival message is encapsulated with a second session mode identification, and a second session mode represented by the second session mode identification refers to sending response information that does not carry relevant data.

The individual modules in the above calling device can be implemented in whole or in part by software, hardware and combinations thereof. Each of the above modules may be embedded in hardware form or independent of a processor in a computer device, or may be stored in software form on a memory in the computer device so that the processor can be called to perform the operations corresponding to each of the above modules.

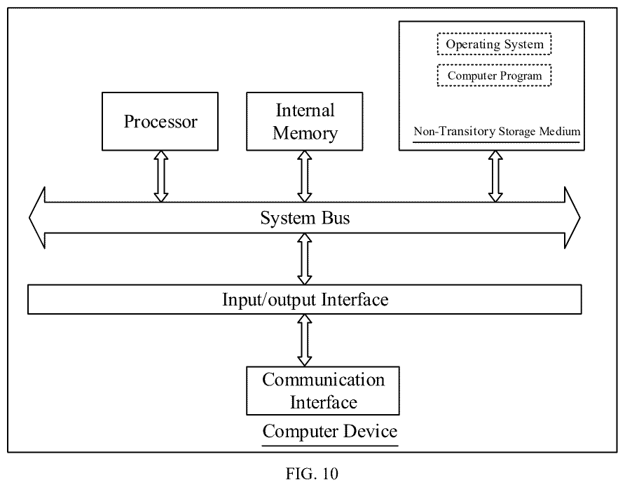

In some embodiments, a computer device is provided, which may be a gateway, a robot, or a calling terminal. A diagram illustrating an internal configuration of the computer device may be shown in FIG. 10. The computer device includes a processor, a memory, and a communication interface connected via a system bus. The processor of the computer device is configured to provide computing and control capabilities. The memory of the computer device includes a non-transitory storage medium and an internal memory. The non-transitory storage medium stores operating systems and computer programs. The internal memory provides an environment for the operation of the operating systems and the computer programs in the non-transitory storage medium. The communication interface of the computer device is configured to communicate with an external terminal via a network connection. The computer programs are executed by the processor in order to implement a calling method.

It should be understood by a person of ordinary skill in the art that the configuration illustrated in FIG. 10 is only a block diagram of part of the configuration related to the solution of the present disclosure, and does not constitute a limitation on the computer device to which the solution of the present disclosure is applied. A specific the computer device may include more or less components than those shown in the figure, or may combine some components, or may have a different arrangement of components.

In some embodiments, a computer device is provided. The computer device includes a memory and a processor. The memory stores a computer program, and the processor implements the steps in each of the method embodiments described above when executing the computer program.

In some embodiments, a computer-readable storage medium is provided, storing a computer program. When the computer program is executed by a processor, the steps in each of the method embodiments described above are implemented.

In some embodiments, a computer program product is provided, including a computer program. When the computer program is executed by a processor, the steps in each of the method embodiments described above are implemented.

A person of ordinary skill in the art may understand that implementation of all or part of the processes in the methods of the above embodiments may be completed by instructing the relevant hardware through a computer program. The computer program may be stored in a non-transitory computer-readable storage medium. When the computer program is executed, it may include the processes of the embodiments of the above methods. Any reference to memory, database or other medium used of the embodiments provided in the present disclosure may include at least one of a non-transitory and a transitory memory. The non-transitory memory may include a read-only memory (ROM), a magnetic tape, a floppy disk, a flash memory, an optical memory, a high-density embedded non-transitory memory, a resistive random-access memory (ReRAM), a magneto resistive random-access memory (MRAM), a ferroelectric random-access memory (FRAM), a phase change memory (PCM), or a graphene memory, etc. The transitory memory may include a random-access memory (RAM) or an external cache memory, etc. As an illustration rather than a limitation, the random-access memory may be in various forms, such as a static random-access memory (SRAM) or a dynamic random-access memory (DRAM), etc. The databases involved of the embodiments provided by the present disclosure may include at least one of a relational database and a non-relational database. The non-relational database may include, but is not limited to, a blockchain-based distributed database, etc. The processor involved of the embodiments provided by the present disclosure may be, but is not limited to, a general purpose processor, a central processor, a graphics processor, a digital signal processor, a programmable logic device, a data processing logic device based on quantum computation, and the like.

The technical features in the above embodiments may be combined arbitrarily. For concise description, not all possible combinations of the technical features in the above embodiments are described. However, provided that they do not conflict with each other, all combinations of the technical features are to be considered to be within the scope described in this specification.

The above-mentioned embodiments only describe several implementations of the present disclosure, and their description is specific and detailed, but should not be understood as a limitation on the patent scope of the present disclosure. It should be noted that, for a person of ordinary skill in the art may further make variations and improvements without departing from the conception of the present disclosure, and these all fall within the protection scope of the present disclosure. Therefore, the protection scope of the present disclosure should be subject to the appended claims.

1. A robot calling system based on LoRa, the calling system comprising: a LoRa gateway, at least one calling terminal, and a robot cluster, the at least one calling terminal and the robot cluster establishing LoRa communication with the LoRa gateway;
wherein the calling terminal is configured to encapsulate and generate a robot call request based on a custom serial communication protocol, and send the robot call request to the LoRa gateway;
the LoRa gateway is configured to determine a target robot from the robot cluster in response to the robot call request, and send a control instruction to the target robot; and
the target robot is configured to go to a location of the calling terminal in response to the control instruction.

2. The robot calling system based on LoRa according to claim 1, wherein the control instruction comprises a unique identification of the calling terminal, and the target robot is further configured to:
determine a map location of the calling terminal based on the unique identification of the calling terminal; and
go to the location of the calling terminal based on the map location.

3. The robot calling system based on LoRa according to claim 1, wherein the control instruction comprises a map location of the calling terminal, and the target robot is further configured to:
go to the location of the calling terminal based on the map location;
wherein the map location is determined by the LoRa gateway based on a unique identification of the calling terminal contained in the robot call request.

4. The robot calling system based on LoRa according to claim 1, wherein the custom serial communication protocol comprises a custom session mode field;
the target robot is further configured to encapsulate and generate an arrival message based on the custom serial communication protocol when arriving at the location of the calling terminal, and send the arrival message to the LoRa gateway; the arrival message is encapsulated with a second session mode identification, and a second session mode represented by the second session mode identification refers to sending response information that does not carry relevant data;
the LoRa gateway is further configured to send an arrival prompt instruction to the calling terminal in response to the arrival message, and return the response information that does not carry the relevant data to the target robot based on the second session mode identification; and
the calling terminal is further configured to output arrival prompt information in response to the arrival prompt instruction; the arrival prompt information is configured to prompt that the target robot has arrived at the calling terminal.

5. The robot calling system based on LoRa according to claim 1, wherein the LoRa gateway comprises a gateway and a cloud platform.

6. The robot calling system based on LoRa according to claim 5, wherein the gateway communicates with the cloud platform, the gateway communicates with the calling terminal, and the cloud platform communicates with the robot cluster.

7. The robot calling system based on LoRa according to claim 5, wherein the gateway is configured to achieve communication between the calling terminal and the robot cluster, and the cloud platform is configured to assist the gateway in calculating relevant data.

8. A calling method, applied to a LoRa gateway, the method comprising:
obtaining a robot call request encapsulated and generated by a calling terminal based on a custom serial communication protocol;
determining a target robot from a robot cluster in response to the robot call request; and
sending a control instruction to the target robot, such that the target robot goes to a location of the calling terminal in response to the control instruction.

9. The calling method according to claim 8, wherein determining the target robot from the robot cluster in response to the robot call request comprises:
obtaining state information reported by the robot cluster; and
determining, based on the state information, a robot whose state information is an idle state as the target robot from the robot cluster based on the state information.

10. The calling method according to claim 8, wherein determining the target robot from the robot cluster in response to the robot call request comprises:
obtaining state information and location information reported by the robot cluster;
obtaining a map location of the calling terminal;
determining robots whose state information is an idle state from the robot cluster based on the state information; and
determining a robot closest to the calling terminal as the target robot from the robots whose state information is an idle state based on the map location of the calling terminal and the location information.

11. The method according to claim 8, wherein the custom serial communication protocol has a custom session mode field, the robot call request comprises a first session mode identification in the session mode field, the custom serial communication protocol further has a custom source address field, the robot call request further comprises an address of the calling terminal in the source address field, and after sending the control instruction to the target robot, such that the target robot goes to the location of the calling terminal in response to the control instruction, the method further comprises:
returning call success response information matching the first session mode identification to the calling terminal based on the address of the calling terminal.

12. The method according to claim 11, wherein a first session mode represented by the first session mode identification refers to that response information carrying relevant data needs to be sent, and the method further comprises:
returning call failure response information to the calling terminal based on the first session mode identification if there is no target robot in an idle state.

13. The method according to claim 8, wherein the method further comprises:
determining state information of the target robot during a movement of the target robot to the location of the calling terminal; and
performing a response processing for forced occupation in a case that the state information indicates that the target robot is forcibly occupied.

14. The method according to claim 8, wherein the method further comprises:
receiving an arrival message sent by the target robot after the target robot arrives at the location of the calling terminal, the arrival message being encapsulated and generated based on the custom serial communication protocol, the arrival message being encapsulated with a second session mode identification, and a second session mode represented by the second session mode identification referring to sending response information that does not carry relevant data; and
generating an arrival prompt instruction in response to the arrival message to control the calling terminal to output arrival prompt information based on the arrival prompt instruction, and returning response information that does not carry relevant data to the target robot based on the second session mode identification, the arrival prompt information being configured to prompt that the target robot has arrived at the calling terminal.

15. A calling method, applied to a calling terminal, the method comprising:
encapsulating and generating a robot call request based on a custom serial communication protocol, and sending the robot call request to a LoRa gateway, such that the LoRa gateway determines a target robot based on the robot call request, and sends a control instruction to the target robot, such that the target robot goes to a location of the calling terminal in response to the control instruction.

16-17. (canceled)

18. A computer device comprising a memory and a processor, wherein the memory stores a computer program, and the processor, when executing the computer program, implements steps of the method of claim 8.

19. A non-transitory computer-readable storage medium having a computer program stored therein, wherein when the computer program is executed by a processor, steps of the method of claim 8 are implemented.

20. A computer program product comprising a computer program, wherein when the computer program is executed by a processor, steps of the method of claim 8 are implemented.

21. A computer device comprising a memory and a processor, wherein the memory stores a computer program, and the processor, when executing the computer program, implements steps of the method of claim 15.

22. A non-transitory computer-readable storage medium having a computer program stored therein, wherein when the computer program is executed by a processor, steps of the method of claim 15 are implemented.
